(19) United States
(12) Patent Application Publication
(10) Pub. No.: US 2024/0295206 A1
(43) Pub. Date: Sep. 5, 2024

(54) FUEL SYSTEM HAVING FUEL INJECTOR BOOT ASSEMBLY WITH AIR GAP STANDOFF PROTRUSIONS

(71) Applicant: Caterpillar Inc., Peoria, IL (US)

(72) Inventor: Kenth I. Svensson, Peoria, IL (US)

(73) Assignee: Caterpillar Inc., Peoria, IL (US)

(21) Appl. No.: 18/116,418

(22) Filed: Mar. 2, 2023

(51) Int. Cl. F02M 61/16; F02M 51/06

(52) U.S. Cl. CPC F02M 61/167; F02M 51/061

(57) ABSTRACT

A boot in a boot assembly in a fuel system includes an elongate boot body defining a longitudinal axis and having an inner boot surface. An injector portion of the boot has a window formed therein receiving an electrical connector of a fuel injector. The injector portion also includes a plurality of radially inward standoff protrusions in contact with the fuel injector to maintain an air gap clearance between an inner surface of the boot and the fuel injector.

### TECHNICAL FIELD

The present disclosure relates generally to a boot in a fuel system, and more particularly to a boot having standoff protrusions to maintain an air gap between a fuel injector and an inner boot surface.

### BACKGROUND

The fuel system in a modern internal combustion engine is often the most complex and expensive part of the equipment. Fuel is typically pressurized to a range of pressures depending upon application and injection location, and delivered for combustion in one or more shots of fuel into a cylinder by way of precisely controlling electrically and/or hydraulically actuated components in fuel injectors. Pressurized fuel systems can require specialized sealing and fuel containment apparatus. For regulatory and other purposes higher pressure portions of a fuel system often employ double-walled containment, such that in the event of a liquid fuel and/or fuel vapor leak fuel is contained in a secondary system outside of the highly pressurized portions and can be returned to a fuel tank or otherwise safely handled.

A component known as a boot is sometimes used in pressurized fuel systems and can assist in positioning and/or protecting certain components, including fuel injectors and fuel connections. An example boot employed in a fuel system is known from co-pending application Ser. No. 17/895,564, filed Aug. 25, 2022, to Wiebrecht. While the designs proposed in Wiebrecht offer promise, there is always room for improvement and development of alternative strategies.

### SUMMARY OF THE INVENTION

In one aspect, a fuel system includes a fuel injector including an injector housing having a fuel inlet and a fuel outlet formed therein, and an electrical connector projecting from the injector housing. The fuel system further includes a fuel conduit connected to the fuel injector, and a boot. The boot includes an elongate boot body defining a longitudinal axis and having an inner boot surface extending circumferentially around the longitudinal axis and forming a central cavity extending between an injector portion of the elongate boot body receiving the fuel injector, and a conduit portion of the elongate boot body receiving the fuel conduit. The injector portion includes a window formed at least partially therein receiving the electrical connector and a plurality of radially inward standoff protrusions in contact with the fuel injector so as to maintain an air gap between the fuel injector and the inner boot surface.

In another aspect, a boot assembly for a fluid system includes a fuel injector including an injector housing having a fuel inlet and a fuel outlet formed therein, and an electrical connector projecting from the injector housing. The boot assembly further includes a boot including an elongate boot body defining a longitudinal axis and having an inner boot surface extending circumferentially around the longitudinal axis and forming a central cavity extending between an injector portion of the elongate boot body receiving the fuel injector, and a conduit portion of the elongate boot body. The elongate boot body further includes a window formed at least in part in the injector portion and receiving the electrical connector, and a plurality of radially inward standoff protrusions in contact with the fuel injector so as to maintain an air gap between the fuel injector and the inner boot surface.

In still another aspect, a boot for a fuel injector and conduit assembly in a fuel system includes an elongate boot body defining a longitudinal axis and including an injector portion, a conduit portion, an outer boot surface, and an inner boot surface extending circumferentially around the longitudinal axis and forming a central cavity extending from an open first axial end formed in the injector portion to an open second axial end formed in the conduit portion. The elongate boot body further includes a plurality of standoff protrusions within the injector section. The plurality of standoff protrusions project radially inward from the inner boot surface and define a circle centered on the longitudinal axis so as to support a fuel injector within the injector portion at an air gap clearance from the inner boot surface.

### BRIEF DESCRIPTION OF THE DRAWINGS

FIG. 1 is a diagrammatic view of an engine system, according to one embodiment;

FIG. 2 is a sectioned side diagrammatic view of a boot assembly, according to one embodiment:

FIG. 3 is a diagrammatic view of a boot, according to one embodiment:

FIG. 4 is a sectioned view of the boot as in FIG. 3:

FIG. 5 is a diagrammatic view of a boot, according to another embodiment:

FIG. 6 is a sectioned view of a boot as in FIG. 5; and

FIG. 7 is a sectioned view of a boot according to yet another embodiment.

### DETAILED DESCRIPTION

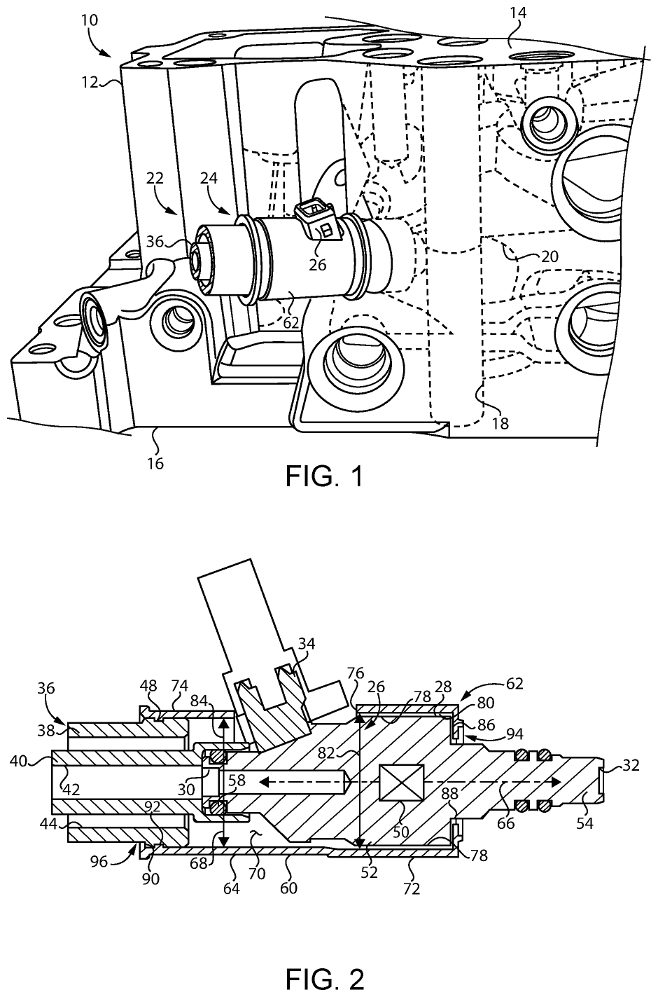

Referring to FIG. 1, there is shown an internal combustion engine system 10, according to one embodiment. Engine system 10 includes a cylinder head 12 having an upper cylinder head surface 14, a lower cylinder head surface 16, and bolt bores 18 for extending between upper cylinder head surface 14 and lower cylinder head surface 16. Other typical features for transfer of fluids including engine coolant and/or oil may extend through cylinder head 12. Cylinder head 12 may be a cylinder head section associated with one combustion cylinder in a cylinder block, or a slab cylinder head associated with multiple combustion cylinders. Engine system 10 may be implemented in a variety of applications, including for electrical power generation, for propelling a land vehicle or a marine vessel, or operating a pump or compressor to name a few examples. Engine system 10 may include any number of combustion cylinders in any suitable arrangement, such as an inline pattern, a V-pattern, or still another. Engine system 10 may be operated on a liquid primary fuel, and dual-fuel pilot ignited using a compression-ignition liquid fuel, although the present disclosure is not thereby limited. A spark-ignited strategy is also within the scope of the present disclosure. An example liquid primary fuel includes methanol, although the present disclosure is also not thereby limited in this regard.

Cylinder head 12 further includes one or more intake ports 20 formed therein. In a practical implementation engine system 10 is port-injected with liquid methanol fuel. The methanol fuel may be ignited by way of a compression-ignited direct injection of a diesel distillate fuel or ignited via dimethyl ether, for example. As will be further apparent from the following description engine system 10 is uniquely configured by way of fuel system apparatus for containment of liquid fuel and fuel vapors as well as ventilation of fuel supply and containment apparatus. While aspects of the present disclosure are described in the context of a fuel system, in other instances teachings herein could be applied in a different type of fluid system, such as system supplying and delivering oil in an engine or other machinery context, or still other environments.

To this end, engine system 10 further includes a fuel system 22. Fuel system 22 includes a fuel injector and conduit assembly 24. Referring also now to FIG. 2, assembly 24 includes a fuel injector 26, and fuel injector 26 includes an injector housing 28 having a fuel inlet 30 and a fuel outlet 32 formed therein, and an electrical connector 34 projecting from injector housing 28. Fuel injector 26 also includes an electrically actuated valve assembly 50. Fuel injector 26 may be a fuel injector of known design having a known configuration and operation of valve assembly 50 to inject a fuel, such as methanol, from fuel outlet 32 into a fuel port in cylinder head 12 that fluidly connects to intake port 20. An example fuel injector construction is set forth in co-pending application Ser. No. 17/895,564, referenced above.

Fuel system 22 and assembly 24 further include a fuel conduit 36 connected to fuel injector 26. Fuel conduit 36 may include a double-walled fuel conduit having an outer wall 38 and an inner wall 40 defining a fuel supply passage 42 fluidly connected to fuel inlet 30, and also to a fuel pressurization pump and a liquid fuel supply such as a methanol fuel tank (not shown). An interwall space 44 typically having the form of an annulus is defined between outer wall 38 and inner wall 40. In a practical implementation strategy, a vacuum is drawn on interwall space 44 such that a negative pressure is continuously applied. In the event of fuel leakage the negative pressure can assist in ensuring that any leaked liquid fuel and/or vapors can be returned to a fuel tank, for example, or safely discharged to ambient. Inner wall 40 may further include an injector fitting 46 coupled to and in contact with a body portion 52 of fuel injector 26. A tip portion 54 of fuel injector 26 projects from body portion 52. An O-ring 58 may be provided to seal between injector fitting 46 and body portion 52.

Fuel system 22 further includes a boot 60 in a boot assembly 62. Boot 60 includes an elongate boot body 64 defining a longitudinal axis 66. Boot body 64, referred to herein at times interchangeably with boot 60, includes an inner boot surface 68 extending circumferentially around longitudinal axis 66 and forming a central cavity 70 extending between an injector portion 72 of boot body 64 receiving fuel injector 26, and a conduit portion 74. Conduit portion 74 of boot body 64 receives fuel conduit 36. Injector portion 72 includes a window 76 formed at least partially therein and receiving electrical connector 34. Injector portion 72 also includes a plurality of radially inward standoff protrusions 78 in contact with fuel injector 26 so as to maintain an air gap 80 between a fuel injector 26 and inner boot surface 68. During service a vacuum may be pulled on interwall space 44 to draw air into central cavity 70 through window 76 or another opening in boot body 64. Based on the vacuum, or other factors, in some instances, inner boot surface 64 could collapse in contact with fuel injector 26 preventing or reducing the potential for air flow through air gap 80. Standoff protrusions 78 can reduce or eliminate such tendency to collapse. Boot body 64 may be formed of a deformable, non-metallic material such as natural rubber or a suitable natural or synthetic rubber-like material including any of a variety of different polymeric materials readily commercially available. Fuel conduit 36 may be formed of a suitable metallic material such as steel.

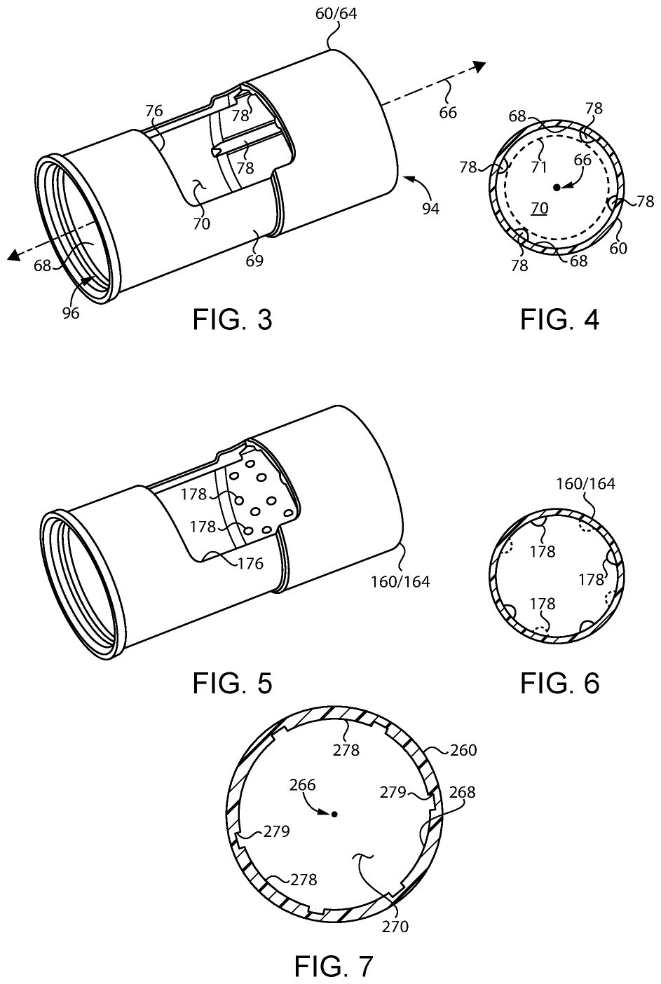

Radially inward standoff protrusions 78 may be spaced apart in at least one of a circumferential aspect or an axial aspect, and project radially inward from inner boot surface 68. In an embodiment, radially inward standoff protrusions 78 are spaced apart in the at least one of a circumferential aspect or an axial aspect in a regular pattern. An irregular distribution is nevertheless within the scope of the present disclosure. Embodiments are also contemplated wherein standoff protrusions 78 have the form of spiraling protrusions providing a generally axial flow path. Referring also now to FIGS. 3 and 4, radially inward standoff protrusions 78 may include at least one of ribs or bumps, and in the embodiment of FIGS. 3 and 4 include ribs elongated in an axial direction. Elongated in an axial direction means a direction of elongation has an axial aspect, not necessarily that the ribs are aligned necessarily parallel to longitudinal axis 66. A combination of bumps and ribs or other configurations typically, but not necessarily, are contemplated where at least some of radially inward standoff protrusions 78 are elongated. In a practical implementation a number of standoff protrusions 78 is at least three. Standoff protrusions 78 may be understood to be spaced apart in a circumferential aspect, as standoff protrusions 78 are spaced circumferentially around longitudinal axis 66.

As can be further noted from the drawings, boot body 64 includes an outer boot surface 69, and window 76 communicates between outer boot surface 69 and inner boot surface 68. Central cavity 70 extends from an open first axial end 94 formed in injector portion 72 to an open second axial end 96 formed in conduit portion 74. Standoff protrusions 78 may be confined in distribution to injector portion 72, although the present disclosure is not thereby limited.

Referring now to FIG. 5, there is shown a boot 160 and elongate boot body 164 according to another embodiment. Boot body 164 has similarities to boot body 64, and could be considered interchangeable for service with boot body 64, but has certain differences. In boot 160 a window 176 similar to window 76 is shown. A plurality of radially inward standoff protrusion 78 are also part of boot body 164, and have the form of a plurality of bumps. Standoff protrusions 178 could include hemispheric bumps as illustrated, but in other embodiments might include conical bumps, box shaped bumps, or still other shapes. As suggested above, both bumps and elongate ribs could be used in the same embodiment. FIG. 6 shows a sectioned view where a circumferential distribution of standoff protrusions 178 can be seen. It can also be appreciated that bumps 178 shown in dashed lines in FIG. 6 are spaced in an axial aspect from bumps shown in solid lines.

FIG. 7 shows a boot 260 according to yet another embodiment. Boot 260 defines a longitudinal axis 266 and may be similar in construction and functionality to other embodiments discussed herein, but again has certain differences. Boot 260 includes an inner surface 268 extending circumferentially around longitudinal axis 266 and forming a central cavity 270. Boot 260 may generally be configured analogously to other embodiments herein, but instead includes standoff protrusions 278 in an alternating arrangement with grooves or channels 279 that are relatively narrower in a circumferential direction than standoff protrusions 278. Channels 279 are formed in inner surface 268 and extend radially outward. Standoff protrusions 278 might be elongated in an axial direction, have the form of spirals, or still another configuration. Those skilled in the art will envision a great variety of different forms of standoff protrusions within the scope of the present disclosure.

Returning focus to FIG. 2, in the illustrated embodiment injector portion 72 may define a larger inner diameter dimension 82 at locations between the plurality of standoff protrusions 78. Conduit portion 74 defines a smaller inner diameter dimension 84. At least a portion of inner boot surface 68 within conduit portion 74 may be uniformly cylindrical. Injector portion 72 further includes a radially inward wall 86 forming an opening 88 in communication with central cavity 70. Fuel injector 26 abuts radially inward wall 86. Conduit portion 74 also includes a radially inward protrusion 92 extending circumferentially around longitudinal axis 66 and is fitted in a circumferential groove 48 formed in outer wall 38. Conduit portion 74 also forms a second opening 90 in communication with central cavity 70. As also depicted in FIG. 4 standoff protrusions 78 define a circle 71 centered on longitudinal axis 66 such that standoff protrusions 78 support fuel injector 26 within injector portion 72 at an air gap clearance from inner boot surface 68.

### INDUSTRIAL APPLICABILITY

Referring to the drawings generally, during service valve assembly 50 can be energized to inject a fuel via fuel injector 26 into intake port 20 for combustion in a cylinder in engine system 10. A vacuum is pulled on conduit 36, providing negative pressure in interwall space 44. The negative pressure can cause a flow of air to pass through boot assembly 62 and draw liquid fuel or fuel vapors leaked from fuel injector and/or conduit assembly 24 back to a fuel tank or other vessel for containment, or potentially for safe discharge to ambient. Radially inward standoff protrusions as discussed herein assist in preventing collapse of boot 60 against fuel injector 26.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A fuel system comprising:
a fuel injector including an injector housing having a fuel inlet and a fuel outlet formed therein, and an electrical connector projecting from the injector housing;
a fuel conduit connected to the fuel injector;
a boot including an elongate boot body defining a longitudinal axis and having an inner boot surface extending circumferentially around the longitudinal axis and forming a central cavity extending between an injector portion of the elongate boot body receiving the fuel injector, and a conduit portion of the elongate boot body receiving the fuel conduit; and
the injector portion having a window formed at least partially therein receiving the electrical connector, and a plurality of radially inward standoff protrusions in contact with the fuel injector so as to maintain an air gap between the fuel injector and the inner boot surface.

2. The fuel system of claim 1 wherein the plurality of radially inward standoff protrusions are spaced apart in at least one of a circumferential aspect or an axial aspect and project radially inward from the inner boot surface.

3. The fuel system of claim 2 wherein the plurality of radially inward standoff protrusions are spaced apart in the at least one of a circumferential aspect or an axial aspect in a regular pattern.

4. The fuel system of claim 2 wherein the plurality of radially inward standoff protrusions include at least one of ribs or bumps.

5. The fuel system of claim 4 wherein the plurality of radially inward standoff protrusions are elongated in an axial direction.

6. The fuel system of claim 1 wherein the injector portion defines a larger inner diameter dimension, and the conduit portion defines a smaller inner diameter dimension, and the injector portion includes a radially inward wall forming an opening in communication with the central cavity, and the fuel injector abuts the radially inward wall.

7. The fuel system of claim 6 wherein the conduit portion forms a second opening in communication with the central cavity and includes a radially inward protrusion engaged in a groove formed in the fuel conduit.

8. The fuel system of claim 7 wherein the fuel conduit includes a double-walled fuel conduit defining an interwall space fluidly connected to the air gap.

9. A boot assembly for a fluid system comprising:
a fuel injector including an injector housing having a fuel inlet and a fuel outlet formed therein, and an electrical connector projecting from the injector housing;
a boot including an elongate boot body defining a longitudinal axis and having an inner boot surface extending circumferentially around the longitudinal axis and forming a central cavity extending between an injector portion of the elongate boot body receiving the fuel injector, and a conduit portion of the elongate boot body; and
the elongate boot body further including a window formed at least in part in the injector portion and receiving the electrical connector, and a plurality of radially inward standoff protrusions in contact with the fuel injector so as to maintain an air gap between the fuel injector and the inner boot surface.

10. The boot assembly of claim 9 wherein the plurality of radially inward standoff protrusions are regularly spaced in at least one of a circumferential aspect or an axial aspect and project radially inward from the inner boot surface.

11. The boot assembly of claim 9 wherein at least a portion of the inner boot surface is uniformly cylindrical within the conduit section, and the conduit section includes a radially inward protrusion extending circumferentially around the longitudinal axis.

12. The boot assembly of claim 9 wherein the plurality of radially inward standoff protrusions include at least one of ribs or bumps.

13. The boot assembly of claim 12 wherein at least some of the plurality of radially inward standoff protrusions are elongated.

14. The boot assembly of claim 13 wherein the plurality of radially inward standoff protrusions includes at least three longitudinally extending ribs.

15. The boot assembly of claim 12 wherein the plurality of radially inward standoff protrusions are spaced apart in both a circumferential aspect and an axial aspect.

16. The boot assembly of claim 9 wherein the injector portion defines a larger inner diameter dimension defined at locations between the plurality of standoff protrusions, and the conduit portion defines a smaller inner diameter dimension, and the injector portion includes a radially inward wall forming a first opening in communication with the central cavity, and the conduit portion includes a radially inward protrusion extending circumferentially around the longitudinal axis.

17. A boot for a fuel injector and conduit assembly in a fuel system comprising:
an elongate boot body defining a longitudinal axis and including an injector portion, a conduit portion, an outer boot surface, and an inner boot surface extending circumferentially around the longitudinal axis and forming a central cavity extending from an open first axial end formed in the injector portion to an open second axial end formed in the conduit section;
the elongate body further including a plurality of standoff protrusions within the injector section; and
the plurality of standoff protrusions projecting radially inward from the inner boot surface and defining a circle centered on the longitudinal axis so as to support a fuel injector within the injector portion at an air gap clearance from the inner boot surface.

18. The boot of claim 17 wherein the plurality of standoff protrusions includes at least one of ribs or bumps.

19. The boot of claim 18 wherein the plurality of standoff protrusions includes a plurality of ribs.

20. The boot of claim 19 wherein the plurality of standoff protrusions includes a plurality of bumps.
